(19) United States
(12) Patent Application Publication
(10) Pub. No.: US 2002/0087317 A1
(43) Pub. Date: Jul. 4, 2002

(54) Computer-implemented dynamic pronunciation method and system

(76) Inventors: Victor Wai Leung Lee, Waterloo (CA); Otman A. Basir, Kitchener (CA); Fakhreddine O. Karray, Waterloo (CA); Jiping Sun, Waterloo (CA); Xing Jing, Waterloo (CA)

Correspondence Address: Jones, Day, Reavis and Pogue, North Point, 901 Lakeside Avenue, Cleveland, OH, 44114, US

(21) Appl. No.: 09/863,947

(22) Filed: May 23, 2001

Related U.S. Application Data
(60) Provisional application No. 60/258,911, filed on Dec. 29, 2000.

(51) Int. Cl. G10L 15/18

(52) U.S. Cl. 704/257

(57) ABSTRACT

A computer-implemented dynamic pronunciation system and method that includes a dictionary storage unit for containing word pronunciation rules. A dictionary generation unit determines a first set of possible pronunciation rules for a pre-selected word. A neural network accepts word spelling as an input and generates at least one pronunciation rule as an output. The pronunciation rule from the neural network is used within the first set of possible pronunciation rules for the pre-selected word to form a pronunciation dictionary.

### RELATED APPLICATION

This application claims priority to U.S. provisional application Serial No. 60/258,911 entitled “Voice Portal Management System and Method” filed Dec. 29, 2000. By this reference, the full disclosure, including the drawings, of U.S. provisional application Serial No. 60/258,911 are incorporated herein.

### FIELD OF THE INVENTION

The present invention relates generally to computer speech processing systems and more particularly, to computer systems that recognize speech.

### BACKGROUND AND SUMMARY OF THE INVENTION

Pronunciation dictionaries have been used to assist in the recognition of speech. These pronunciation dictionaries associate how a word is to be pronounced with the spelling of the word. Traditional techniques for generating accurate pronunciation for a dictionary are accomplished by actual recordings of user speech. The traditional techniques also build acoustic models (such as Hidden Markov Models) to generate the pronunciations. However, composing necessary acoustic models for different vocabulary set is both a cumbersome and time-consuming process. Moreover, when a large amount of data are used, the pronunciation rules generated by these acoustic models may contradict each other, because these rules are statically input into the system.

Further areas of applicability of the present invention will become apparent from the detailed description provided hereinafter. It should be understood however that the detailed description and specific examples, while indicating preferred embodiments of the invention, are intended for purposes of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description and the accompanying drawings, wherein:

FIG. 1 is a block diagram depicting a neural network of the present invention that is used in synthesizing speech;

FIG. 2 is a block diagram depicting the use of a neural network within a speech recognition system;

FIG. 3 is an exemplary structure of a neural network of the present invention used in recognizing speech; and

FIG. 4 is a flow chart depicting an exemplary operational scenario of the present invention.

### DETAILED DESCRIPTION OF THE PREFERRED EMBODIMENT

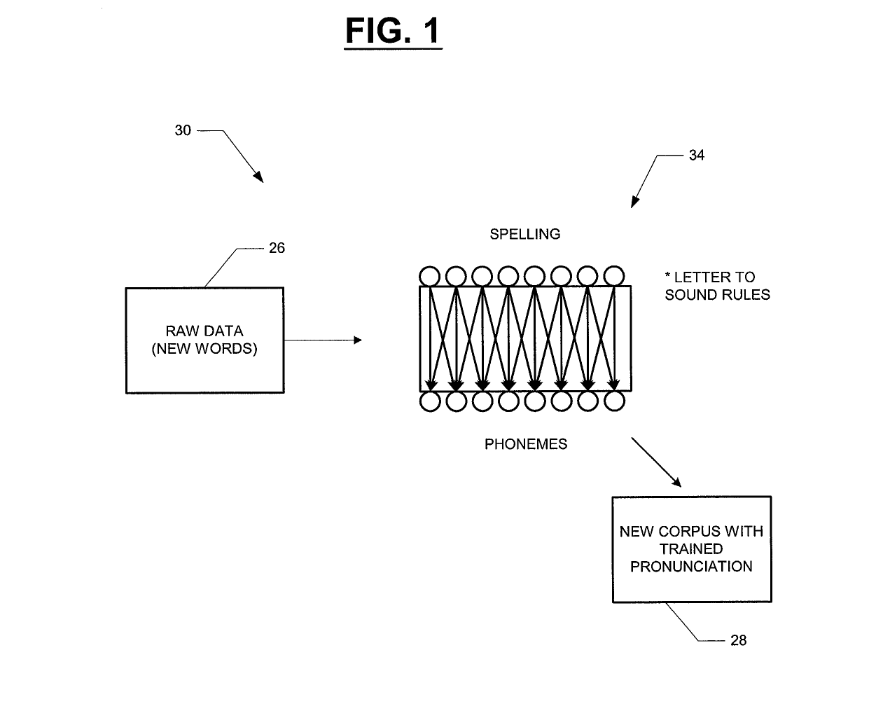

FIG. 1 depicts a dynamic pronunciation dictionary system 30 of the present invention. The system 30 utilizes a neural network 34 to generate letter to sound rules for use in a speech recognition system. The neural network is provided raw data (e.g., new words) for training. The spelling of the words are provided as input 26 to the neural network 34, and the neural network 34 is trained in combination with the defined phonemes of a vocabulary set to generate new rules and to tune existing rules which together indicate how the input words are to be pronounced. It should be understood that the neural network 34 may generate any basic pronunciation unit (such as a phoneme) within the system 30 of the present invention.

The generated letter to sound rules indicate that for a given spelling of an input word, the following phonemes may be used to pronounce the input word. The generated letter to sound rules are included into a corpus 28, such as a pronunciation dictionary and used in an operational application to recognize user input speech. Language models (such as Hidden Markov models) are constructed from the rules of the corpus 28.

More specifically, the present invention trains the neural network 34 to generate accent-specific pronunciation rules. For example, the neural network may generate United States mid-western English speaking accent pronunciation rules, United States southern English speaking accent pronunciation rules, etc. The present invention may utilize these different pronunciation rules in the speech recognition system 43 to determine the accent of a user. The user's accent may be initially recognized by examining at least several words of the user speech to determine which accent pronunciation rules best recognizes the user speech. After the accent has been determined, the correct accent pronunciation rules (such as the United States mid-western English speaking accent pronunciation rules) may be used to better recognize the speech input of the user.

Thus, the neural network 34 of the present invention tunes rules from a pronunciation dictionary according to accents provided. When a user's accent is determined, the neural network 34 can tune the pronunciation dictionary that is used in the operational application by adjusting the rules and creating new rules according to the accent. The original rules of the pronunciation dictionary may also be used as input to operational application.

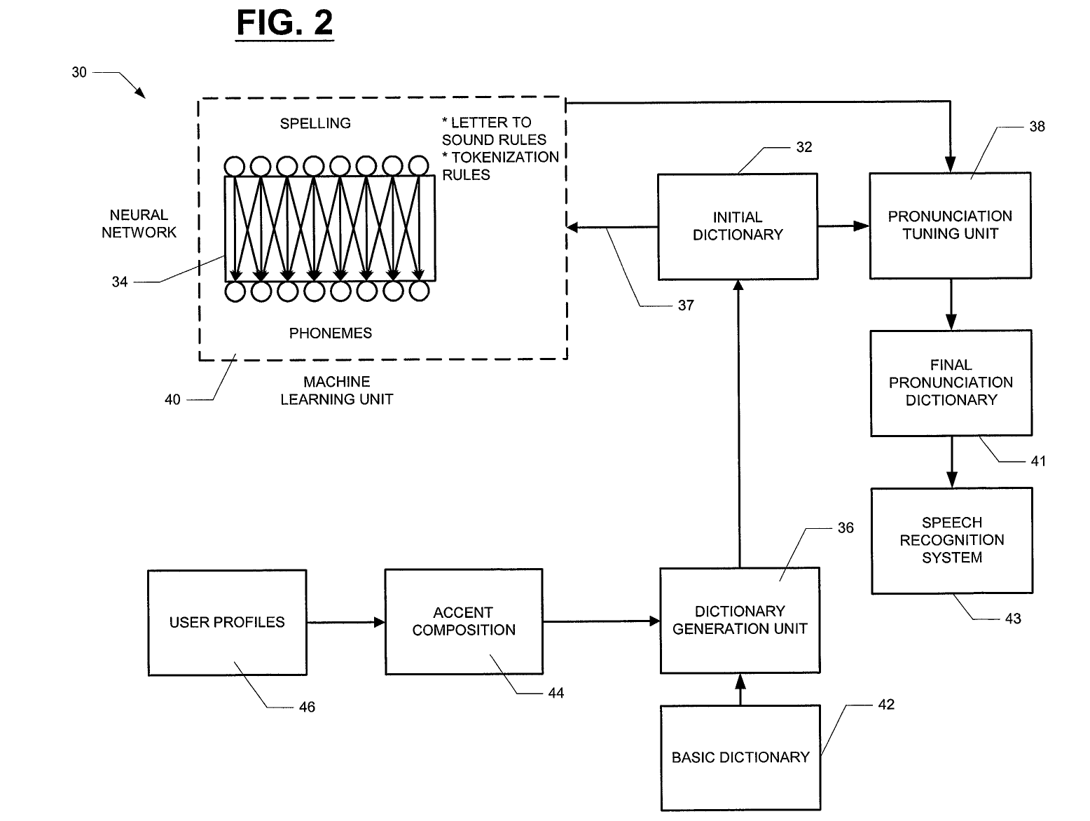

FIG. 2 depicts the system 30 in a more detailed embodiment of the present invention. With reference to FIG. 2, the system 30 contains an initial dictionary 32 that acts as a “starting point” for pronunciation with letter to sound rules for word pronunciation and tokenization rules for partitioning words into basic sounds. The initial dictionary 32 is prepared to be tuned by the pronunciation with letter to sounds rules for word pronunciation and tokenization rules for partitioning words into basic sounds. The initial dictionary also contains basic, predefined pronunciations, in terms of phonemes, which are previously created by acoustic models or pronunciation dictionaries. The neural network 34 allows machine learning that adapts to variations among users' pronunciations and can accommodate different user accents.

Input specific to a basic corpus of an application goes to the dictionary generation unit 36. The dictionary generation unit 36 scans a basic dictionary 42 which has letter to sound rules for pronunciation and tokenization rules for decomposing syllables into phonetic sounds. The words from the basic corpus, with the applicable pronunciation rules, are relayed to the initial dictionary 32, which may be directly processed into the pronunciation tuning unit 38. The dictionary generation unit 36 collects the words and basic pronunciations from the basic dictionary 42. The dictionary generation unit 36 may also collect sets of related accents, pronunciations and phonetic sounds from user profiles 46 and accent composition 44. Together, these pronunciations gathered by the dictionary generation unit 36 form the initial dictionary 32 that is the training data 37 for the neural network 34.

The dictionary generation unit 36 has access to the basic dictionary 42 of common words, letter to sound rules for phonetics, and tokenization rules for partitioning words into smaller units of sound. The dictionary generation unit 36 accesses words from an application and creates the initial dictionary 32. The initial dictionary 32 acts as a repository for the best pronunciations arrived at by the dictionary generation unit 36. The initial dictionary 32 has access to a machine learning unit 40 with a neural network 34 that remembers alternative pronunciations for different letter combinations and can apply them to novel input scenarios. The dictionary generation unit 36 also accesses the accent composition 44 of various user profiles 46. The accent composition 44 of actual user profiles 44 is stored so that the dictionary generation unit 36 may recognize the specific accents of users and generate the initial dictionary 32 according to the accent composition 44 and the basic dictionary 42. In order to implement the accent composition 44, previous user speech requests are recorded and matched to the current user in order to determine if a user profile 46 exists for the current user. The initial dictionary 32 relays this input from the dictionary generation unit 36 to the pronunciation tuning unit 38 and the machine learning unit 40.

The machine learning unit 40 contains the neural network 34 that calibrates differences between the pronunciation of specific words to reduce mapping errors. The machine learning unit 40 has the ability to learn new refinements (such as the accent composition 44 of users) which can increase subsequent efficiency. The pronunciation tuning unit 38 uses the machine learning unit 40 to refine the pronunciation of words from the initial dictionary 32, and transmits the decoded words to the final pronunciation dictionary 41. The pronunciation tuning unit 38 adds some alternative pronunciations for the application corpus. The final pronunciation dictionary 41 is a repository for the preferred selected alternatives of possible pronunciations for a particular word from the application corpus.

For example, if the word “HOME” occurs in an application, the dictionary generation unit 36 checks the basic dictionary 42 for letter to sound rules to use as possibilities for pronouncing “HOME.” Possibilities for pronouncing “HO” of “HOME” might come from the words “HOW,” “HOLE,” or “HOOP.” These possibilities are relayed to the initial dictionary 32 from which the machine learning unit 40 and the pronunciation tuning unit 38 determine the most likely pronunciation. If the neural network 34 has encountered variations of “HO” before and changed “OW” after “H” to a long “O,” the new combination of letters in “HOME” will be facilitated by that experience in machine learning.

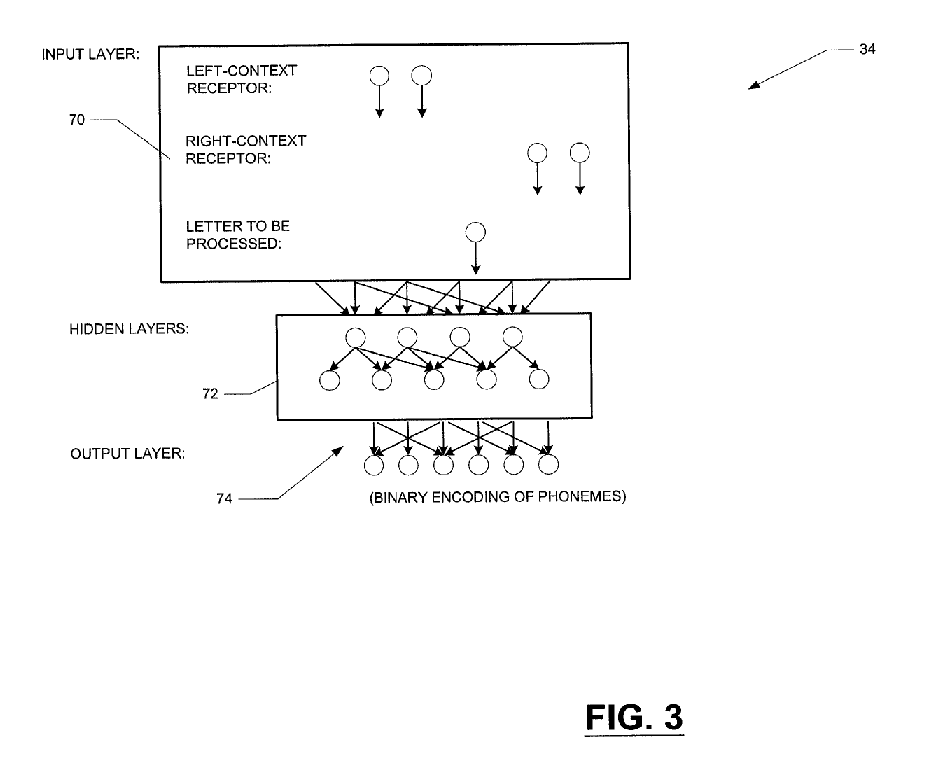

FIG. 3 depicts an exemplary structure of the neural network 34. The neural network 34 includes an input layer 70, one or more hidden layers 72, and an output layer 74. The input layer 70 includes input nodes for the letter to be processed, left-context receptors and right-context receptors. The number of receptors to the right and left of the letter to be processed can be determined by the user, or may be determined by the network 34 based on, for example, the complexity of the language or the length of the word. In this exemplary structure, the neural network 34 includes a two letter bias for the right receptor and the left receptor. Alternatively, for shorter words, a one letter bias may be used for the right receptor and the left receptor.

For example for the word “HOME”, the neural network 34 has the right-context receptor accept as input the letter “O” when it is processing the letter “H” and a null left text receptor. When the neural network 34 is processing the letter “O”, the left-context receptor accepts as input the letter “H” and the right-context receptor accepts as input the letter “M”. The neural network 34 continues to analyze each letter in the word in this manner until the last letter has been processed.

Accordingly, the input size for the neural network 34 is the sum of the sizes of the left receptors, right receptors and the processed letter receptor. The values of each of the receptors is then generated according to the letter that is associated with that receptor.

The hidden layers 72 process the input data based upon how the hidden layers' weights and activation functions are trained. The present invention may use any type of activation function that suits the application at hand, such as a sigmoid squashing function. The output layer 74 generates phonemes based upon the input spelling. In one embodiment of the present invention the phonemes are binary encoded in order to generate more accurate and efficient representations. The ultimate mapping of the input spelled word to a set of phonemes by the neural network 34 is termed a pronunciation rule.

It should be understood that various neural network structures may be utilized by the present invention. For example, the input layer to the neural network may have twenty (20) input nodes to process the letter and the left and right letters; or the neural network may have as many input nodes to simultaneously process all letters of the word. In this latter embodiment, the number of input nodes corresponds to the number of letters in the word to be processed. The hidden layers 72 determine phoneme pronunciation guides based upon each letter and the letter's left and right neighbors.

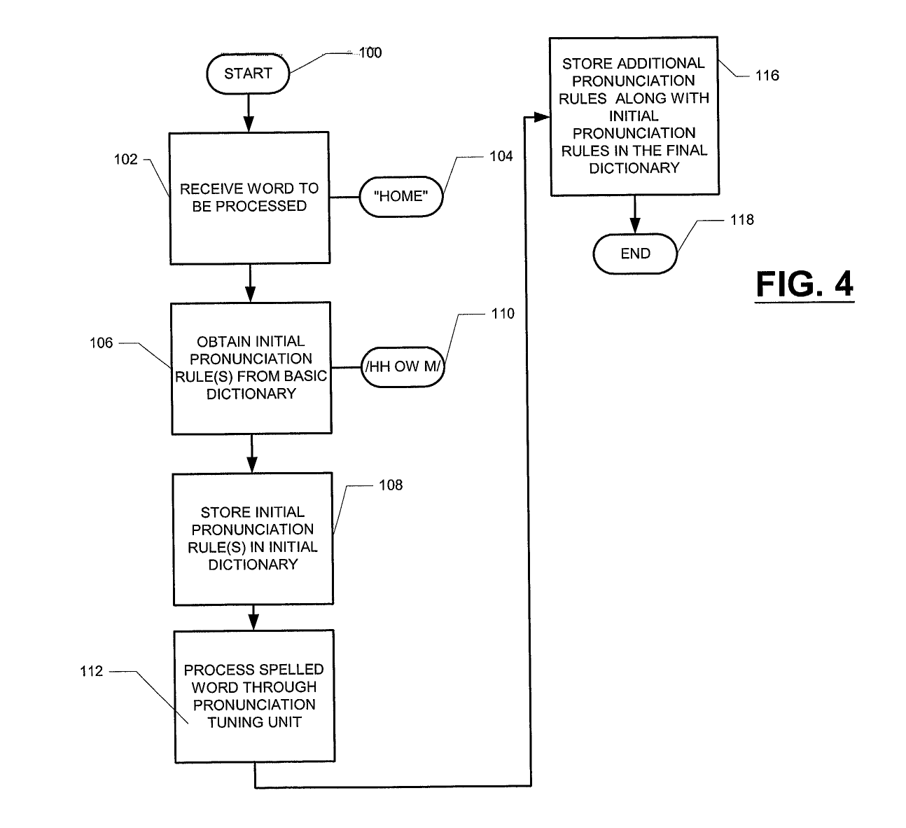

FIG. 4 depicts as an exemplary operational scenario of the present invention wherein the word to be voiced contains the word “HOME”. Start block 100 indicates that process block 102 receives the word “HOME” 104. Process block 106 performs a dictionary lookup from the basic dictionary and obtains the pronunciation /HH OW M/ in step 108. This pronunciation is put in the initial dictionary. At process block 112, the pronunciation tuning unit processes the dictionary lookup through the initial dictionary, thereby yielding a few more “alternative” pronunciations:

HOME/HH OW M/

/HH AX L M/

/HH AX UH M/

The pronunciation tuning unit also uses the neural network of the present invention to fine tune the pronunciations. If the neural network has the experience of changing “HO” from /HH OW/ to/HH AX L/, the new combination of letters “HOME” are added at process block 116 to the final pronunciation rules in addition to the other determined pronunciation rules.

The preferred embodiment described within this document with reference to the drawing figures is presented only to demonstrate an example of the invention. Additional and/or alternative embodiments of the invention will be apparent to one of ordinary skill in the art upon reading this disclosure.

It is claimed:

1. A computer-implemented dynamic pronunciation system comprising:
a first dictionary storage unit that contains word pronunciation rules;
a dictionary generation unit connected to the first dictionary storage unit that determines a first set of possible pronunciation rules for a pre-selected word; and
a neural network whose structure accepts word spelling as an input and generates at least one pronunciation rule as an output, wherein the pronunciation rule from the neural network is used within the first set of possible pronunciation rules for the pre-selected word to form a pronunciation dictionary.

2. The computer-implemented dynamic pronunciation system of claim 1 wherein the neural network generates pronunciation rules that contain accent pronunciation rules.

3. The computer-implemented dynamic pronunciation system of claim 2 wherein the accent pronunciation rules map phonemes to a spelled word.

4. The computer-implemented dynamic pronunciation system of claim 2 wherein the accent pronunciation rules map different sets of phonemes to the pre-selected word.

5. The computer-implemented dynamic pronunciation system of claim 2 wherein each of the sets of phonemes represent a different speaking accent.

6. The computer-implemented dynamic pronunciation system of claim 2 further comprising:
at least one language model that has been constructed from the accent pronunciation rules.

7. The computer-implemented dynamic pronunciation system of claim 2 wherein the language models are hidden Markov language recognition models.
